(19) United States
(12) Patent Application Publication
(10) Pub. No.: US 2016/0047473 A1
(43) Pub. Date: Feb. 18, 2016

(54) CANTED COIL SPRINGS FILLED WITH ELASTIC MATERIALS AND RELATED METHODS

(71) Applicant: Bal Seal Engineering, Inc., Foothill Ranch, CA (US)

(72) Inventors: Mike Foster, Foothill Ranch, CA (US); Brian Carter, Foothill Ranch, CA (US)

(73) Assignee: Bal Seal Engineering, Inc., Foothill Ranch, CA (US)

(21) Appl. No.: 14/827,923

(22) Filed: Aug. 17, 2015

Related U.S. Application Data
(60) Provisional application No. 62/038,500, filed on Aug. 18, 2014.

(51) Int. Cl. F16J 15/32; F16F 3/12

(52) U.S. Cl. CPC F16J 15/3212; F16F 3/12

(57) ABSTRACT

A canted coil spring assembly is disclosed having a plurality of coils and a filler material placed within the coils and in the direction of a centerline that goes through the coils. The plurality of coils have a loading direction that is generally perpendicular to a tangent of the centerline of the coils wherein a load is applied in such direction and causes the coils to deflect generally independently of adjacent coils.

### FIELD OF ART

The present invention generally relates to canted coil springs and more particularly to elastomer filled canted coil springs, applications of elastomer filled canted coil springs, and related methods.

### BACKGROUND

Typically, a canted coil spring is used within an elastomeric ring, also known as a seal element, to form a spring energized seal that provides maximum sealing, aided by the canted coil spring, while yielding low friction between the sealing element and the dynamic surface, such as for rotary or reciprocating applications. Canted coil springs can also be used as electrical contacts that provide efficient signal propagation. The rotary/reciprocating seals and electrical contacts can be utilized in harsh environmental conditions such as mud, water, oil, or other viscous material surroundings.

While a canted coil spring operates by a plurality of coils deflecting in a same general loading direction that is generally perpendicular to a tangent of a centerline of the coils, wherein the coils experience a relatively constant force as deflection occurs over a working range, such capability may be hindered if the plurality of coils are obstructed or interfered with by unwanted surrounding materials, such as mud, slurry, etc. trapping between the coils and limiting the coils' deflection. In addition, unwanted materials packing into the coils limit individual coils to act generally independently of adjacent coils. For example, when an unwanted material such as mud is packed within the coils, the mud may harden and greatly reduce the deflection capability of the canted coil spring. For drilling applications, such hindrance may take place in a riser drilling system and/or riser-less drilling system where the canted coil spring is used as an electrical contact or a spring energizer within a rotary/reciprocating seal in between pipe connections and/or along the pipe lines. Along with the hindrance in canted coil spring capability, the springs need to be washed each time when the pipe needs to be re-connected to another system after being exposed to harsh environmental conditions as mentioned, which can cause inefficiency in the overall drilling process.

### SUMMARY

Aspects of the present invention are directed to canted coil springs that are less susceptible to complications, such as less susceptible to being obstructed by debris and unwanted materials. In some examples, a non-metallic filler material or member, such as an O-ring, is placed within the plurality of coils of a canted coil spring in the direction of the centerline. The placement of the filler material is configured so that the filler material is fully within the coils wherein a cross-sectional outer profile of the filler material is completely within the boundaries of a cross-sectional inner profile of the plurality of coils when load is not present. Some part or parts of the filler member may protrude between gaps of two adjacent coils depending on the relative cross-sectional profiles of the filler member and the coils of the canted coil spring. Such configuration of the filler member within the coils may reduce the amount of unwanted materials being introduced or packed within the plurality of coils and may prevent the mentioned hindrance in deflection capability while maintaining the electrical signal carrying capability and energizing capability within seals. Also, due to smaller empty spacing within the coils with the presence of the filler member, unwanted materials may easily fall off or break apart as the density of the unwanted material present within the coils is greatly reduced by the presence of the filler member. Moreover, efficiency in the overall drilling process, when the filled canted coil spring is used in a downhole application, may be improved since frequent cleaning of the canted coil spring when re-connecting to another drilling system may be reduced.

An example in accordance with aspects of the present disclosure includes a canted coil spring ring and a filler material or member that is located in the direction of a centerline that goes through the plurality of coils and is also completely within the boundaries of the cross-sectional inner profile of the coils when the coils are not loaded. The filler material may comprise an O-ring, a tube, or a conductive elastomer not limited to a generally circular cross-sectional profile. The filler material may be made from an elastomer material, a foam material, a sponge material, a thermoplastic elastomer (TPE), or combinations thereof. Similarly, the plurality of coils of the canted coil spring ring may comprise other geometrical variations of the cross-sectional profile such as rectangular, triangular, and other more complex geometries. Regardless of different geometries of the coils and the filler member, the purpose and usage of the spring to conduct electricity within harsh environmental conditions and effectively work as a spring energizer within a seal while not hindering canted coil spring's deflection capability are described. Methods of using the filled canted coil spring to minimize, reduce, or eliminate unwanted material buildups are also described.

A further aspect of the present disclosure includes a spring assembly comprising a canted coil spring comprising a plurality of coils, a centerline formed through said coils, and a loading direction that is generally perpendicular to a tangent of said centerline; wherein at least a coil of said plurality of coils comprises a cross-sectional inner profile when viewed in a direction of said centerline; wherein at least a coil of said plurality of coils is deflectable generally independently of an adjacent coil of said plurality of coils when a load is applied in said loading direction; a filler member disposed within said plurality of coils in the direction of said centerline; wherein said filler member comprises a cross-sectional outer profile when viewed in the direction of said centerline; and wherein said cross-sectional outer profile of said filler member is within said cross-sectional inner profile of said plurality of coils when the canted coil spring is not loaded.

The spring assembly wherein said plurality of coils each can be deflectable generally independently when loaded.

The spring assembly wherein said filler member can prevent unwanted material to be filled or packed within said plurality of coils that may hinder the performance of the spring assembly when loaded while allowing for minimal effect on the generally independent deflection characteristic of said plurality of coils when loaded.

The spring assembly can further comprise a seal member having a body with an open channel encompassing a cross-sectional outer profile of the canted coil spring.

The spring assembly wherein the seal member can include a sealing lip for sealing against a moving shaft.

The spring assembly wherein the seal member is usable as an axial seal.

The spring assembly wherein the filler member can be hollow.

The spring assembly wherein the filler member can comprise a cross-sectional outer profile that is not round.

The spring assembly wherein the filler member can be an O-ring.

The spring assembly wherein the filler member can be conductive.

The spring assembly wherein the plurality of coils each can comprise a cross-sectional inner profile that is other than round or elliptical.

The spring assembly wherein the filler member can be made from a sponge material or a foam material.

The spring assembly can be used as an electrical contact.

A yet further aspect of the present disclosure is a method for limiting material build up in a spring energized seal. The method can comprise providing a seal body comprising an outer flange and an inner flange connected to a center channel section, said seal body further comprising an open channel and a spring holding space; providing a canted coil spring comprising a plurality of coils with a filler member through the open channel of the seal body and into the spring holding space; wherein at least a coil of said plurality of coils comprises a cross-sectional inner profile when viewed in a direction of said centerline; wherein at least a coil of said plurality of coils is deflectable generally independently of an adjacent coil of said plurality of coils when a load is applied in said loading direction; and wherein said filler member comprises a cross-sectional outer profile when viewed in the direction of said centerline; and wherein said cross-sectional outer profile of said filler member is within said cross-sectional inner profile of said plurality of coils when the canted coil spring is not loaded.

More broadly, the method is for limiting material build up in a filled canted coil spring by providing a canted coil spring comprising a plurality of coils with a filler member through the open channel of the seal body and into the spring holding space; wherein at least a coil of said plurality of coils comprises a cross-sectional inner profile when viewed in a direction of said centerline; wherein at least a coil of said plurality of coils is deflectable generally independently of an adjacent coil of said plurality of coils when a load is applied in said loading direction; and wherein said filler member comprises a cross-sectional outer profile when viewed in the direction of said centerline; and wherein said cross-sectional outer profile of said filler member is within said cross-sectional inner profile of said plurality of coils when the canted coil spring is not loaded.

The method wherein said filler member can contact said cross-sectional inner profile of said plurality of coils.

The method wherein filler member can fill in gaps between two adjacent coils of said plurality of coils.

The method can further comprise a gland and wherein the method can further comprise the step of placing the seal body with said canted coil spring and said filler member in said gland.

The method wherein the filler member can be hollow.

The method wherein the filler member can be an O-ring, a foam, or a sponge.

The present disclosure further includes a spring assembly comprising a canted coil spring comprising a plurality of coils, a centerline going through said coils, and a loading direction that is generally perpendicular to a tangent of said centerline; wherein a coil of said plurality of coils comprises a cross-sectional inner profile when viewed in a direction of said centerline; wherein a coil of said plurality of coils may deflect generally independently of an adjacent coil of said plurality of coils when a load is applied in said loading direction; an elastomeric member disposed within said plurality of coils in the direction of said centerline; wherein said elastomeric member comprises a cross-sectional outer profile when viewed in the direction of said centerline; wherein said cross-sectional outer profile of said elastomeric member is within the boundaries of said cross-sectional inner profile of said plurality of coils when not loaded; and wherein the cross-sectional outer profile of said elastomeric member being within the boundaries of said cross-sectional inner profile of said plurality of coils when not loaded allows for minimal effect on the generally independent deflection characteristic of said plurality of coils when loaded.

Another feature of the present disclosure is a spring assembly comprising a canted coil spring comprising a plurality of coils, a centerline going through said coils, and a loading direction that is generally perpendicular to a tangent of said centerline; wherein a coil of said plurality of coils comprises a cross-sectional inner profile when viewed in a direction of said centerline; wherein a coil of said plurality of coils may deflect generally independently of an adjacent coil of said plurality of coils when a load is applied in said loading direction; an elastomeric member disposed within said plurality of coils in the direction of said centerline;

wherein said elastomeric member comprises a cross-sectional outer profile when viewed in the direction of said centerline; wherein said cross-sectional outer profile of said elastomeric member is within the boundaries of said cross-sectional inner profile of said plurality of coils when not loaded; and wherein the cross-sectional outer profile of said elastomeric member being within the boundaries of said cross-sectional inner profile of said plurality of coils when not loaded prevents unwanted material to be filled or packed within said plurality of coils that may hinder the performance of the spring assembly when loaded, while allowing for minimal effect on the generally independent deflection characteristic of said plurality of coils when loaded.

Yet another aspect of the present disclosure is a seal assembly comprising a canted coil spring comprising a plurality of coils, a centerline going through said coils, and a loading direction that is generally perpendicular to a tangent of said centerline; wherein a coil of said plurality of coils comprises a cross-sectional inner profile when viewed in a direction of said centerline; wherein a coil of said plurality of coils may deflect generally independently of an adjacent coil of said plurality of coils when a load is applied in said loading direction; an elastomeric member disposed within said plurality of coils in the direction of said centerline; wherein said elastomeric member comprises a cross-sectional outer profile when viewed in the direction of said centerline; wherein said cross-sectional outer profile of said elastomeric member is within the boundaries of said cross-sectional inner profile of said plurality of coils when not loaded; and a seal generally encompassing a cross-sectional outer profile of the canted coil spring.

### DESCRIPTION OF DRAWINGS

FIGS. 1A-B show different views of an O-ring filled canted coil spring ring.

FIG. 2 shows a cross-sectional view of an O-ring filled canted coil spring ring.

FIG. 3 shows a plurality of coils of a canted coil spring along with a centerline of the coils and a canting angle of the coils.

FIGS. 4A-B show cross-sectional profiles of the coils and a filler material or filler member when not loaded and loaded.

FIGS. 5A-C show a variety of cross-sectional profiles of the coils and the filler material or filler member when loaded and wherein the filler material comprises different geometries.

FIGS. 6A-C show a variety of cross-sectional profiles of the coils and the filler material when loaded and wherein the coils comprise different geometries.

FIG. 7 shows a cross-sectional profile of the coils and the filler material when loaded and wherein the filler material is conductive.

FIGS. 8A-B show different views of a rotary/reciprocating seal assembly and wherein a canted coil spring ring with a filler member is used.

FIG. 9 shows a cross-sectional profile of a rotary/reciprocating seal assembly wherein a filled canted coil spring ring with a filler member is used.

### DETAILED DESCRIPTION

The detailed description set forth below in connection with the appended drawings is intended as a description of the presently preferred devices, systems, and methods related to filled canted coil springs and applications thereof and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

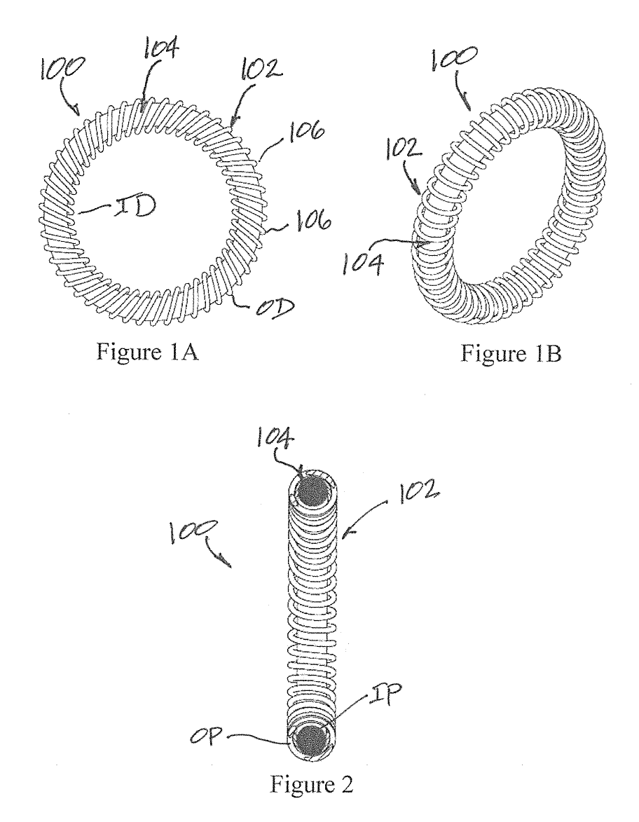

FIGS. 1A-B shows different views of a filled canted coil spring ring 100, which may be a canted coil spring 102 filled with a filler material or filler member 104, such as a non-metallic ring, like an elastomeric O-ring, a ring made from a foam material, from a sponge material, from a thermoplastic elastomer (TPE) material, or combinations thereof. FIG. 1A shows the front view of the filled canted coil spring ring 100 while FIG. 1B shows an isometric view of the same spring filled ring. Both views clearly show a filler material or member 104, wherein the filler member may be an O-ring, located within a plurality of coils 106 of the canted coil spring ring. The canted coil spring 102 comprises a plurality of coils 106 all canted in the same general direction that is generally perpendicular to a tangent of a centerline of the coils. The ring 102 has a ring OD and a ring ID and wherein the coils 106 experience a relatively constant force as deflection occurs over a working range, when the spring OD and spring ID are compressed, for a radial canted coil spring. The filled canted coil spring ring 100 may alternatively be formed using an axial canted coil spring.

In an example, the filler material 104 and the canted coil spring 102 can both start as lengths witch each comprising two free ends. The two lengths can then be connected end to end with the two ends of the filler material 104 bonded and the two ends of the canted coil spring 102 welded to form a filled canted coil spring ring 100.

FIG. 2 is a cross-sectional end view of the filled canted coil spring ring 100 of FIGS. 1A-B, showing half of the filled ring. The present view confirms the location of the filler member 104 within the inside diameter of the plurality of coils 106 of the canted coil spring ring 102. The terms filler member and filler material may be used interchangeably. Such placement of the filler member can reduce build-up of mud, viscous materials, or any other unwanted materials within the coils, mitigating the condition in which the coils can deflect independently from adjacent coils. Said differently, the presence of the filler material 104 inside the coils 106 displaces the free space between the coils and interior of the coils to limit space that mud or other unwanted materials can otherwise collect or build-up. Moreover, the reduction of the build-up of unwanted materials can reduce the number of cleaning of the canted coil spring ring 102 between use since the space in which the unwanted materials can settle is limited; and thus, reducing the density of hardened unwanted materials. Thus, an aspect of the present disclosure is understood to include a method of using the filled canted coil spring in fluid applications with slurries and suspended solids and utilizing the presence of the filler material to reduce, minimize, or eliminate unwanted material buildups within the coils of the canted coil springs and/or between the coils of the canted coil spring.

The reduction of materials building up within the coils 106 can have the added benefit of self-cleaning. That is, by minimizing free space within the coils and consequently how much materials can build up, materials that do form cannot cake around and/or within the coils 106. Thus, the canted coil spring ring 102 is able to clean itself by rubbing against the pipe or pin that the filled spring ring 100 is positioned in, easily knocking off some of the accumulated materials within the coils when the pipes undergo disconnection.

The coils 106 each comprises an inside perimeter IP and an outside perimeter OP. In some examples, due to relative sizes, the coils squeeze the outside surface of the filler material 104 such that some of the filler material protrudes into the gaps between adjacent coils but the filler material does not extend outwardly passed the outside perimeter OP of the coils. In other examples, the filler material 104 is located within the coils but the coils do not squeeze the exterior surface of the filler material. In still other examples, as further discussed below, some or all of the surfaces of the filler material 104 within the filled spring 100 are spaced from the coils while in some examples only part of the filler material is spaced from the coils.

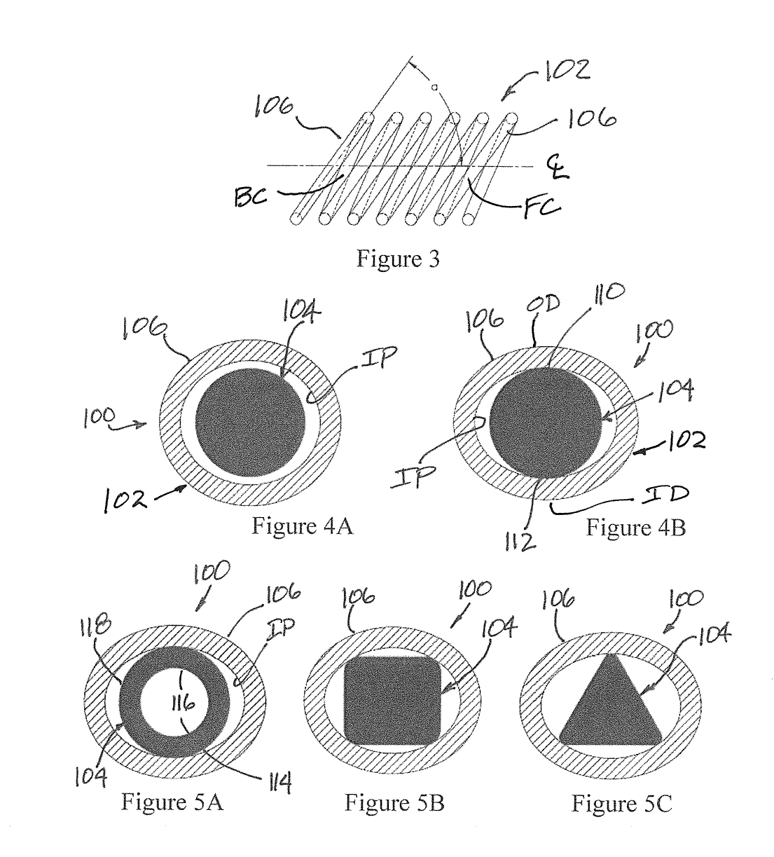

FIG. 3 shows a section of a canted coil spring 102, such as a canted coil spring length, and a centerline going through the plurality of coils 106, wherein the centerline defines the direction of configuration of the filler material or filler member. A canting angle α is shown for the purpose of indicating that the coils are indeed canted about the centerline. Note that not only are front curve FC of the coils are all canted in the same direction, the back curve BC of the coils are all canted in the same generally direction also, which is the nature of canted coil springs and which differentiate them from compression and extension springs. This allows the coils to deflect in a loading direction that is generally perpendicular to a tangent of the centerline.

FIGS. 4A-B shows cross-sectional profiles of two different coils 102 and filler materials or filler members 104 of two different filled canted coil springs 100. FIG. 4A shows a cross-sectional profile of a filler material 104 that is generally circular in cross-sectional shape and wherein the cross-sectional outer profile of the filler material 104 is located well within the boundaries, i.e., well within the inside perimeter IP, of the cross-sectional inner profile of the coils 106 (only one shown) when not loaded. FIG. 4B shows a similar configuration as FIG. 4A except that the coils 106 (only one shown) are loaded and deflected in the loading direction generally perpendicular to the tangent of the centerline and in contact with the filler material or filler member 104 along two opposed sections 110, 112. The coils can be loaded or deflected by applying loads at opposing points, at the OD and ID.

FIGS. 5A-5C show several single coil sections of different filled canted coil springs 100 in accordance with aspects of the present disclosure. The various views show a variety of cross-sectional profiles that the filler materials 104 may embody when placed within the coils 106 under loaded conditions. FIG. 5A shows a filler material or filler member 104 that is hollow such as a tube having a hollow bore 114, and consequently has both a cross-sectional inner profile 116 and a cross-sectional outer profile 118. The hollow filler material 104 of FIG. 5A is placed so that the cross-sectional outer profile 118 of the filler material 104 is within the boundaries of the cross-sectional inner profile IP of the coils 106 when the coils are not loaded. FIG. 5B shows a filler material 104 that is generally rectangular in geometry. The filler material 104 of FIG. 5B is solid but can alternatively have a hollow core. In yet other examples, voids or pockets may be incorporated to decrease the density of the solid filler material 104. FIG. 5C shows a filler material 104 that is generally triangular in geometry, which can have a solid core, a hollow core, voids or pockets, or combinations thereof. Unless indicated otherwise, other filler materials shown herein may have a solid core, a hollow core, voids or pockets, or combinations thereof.

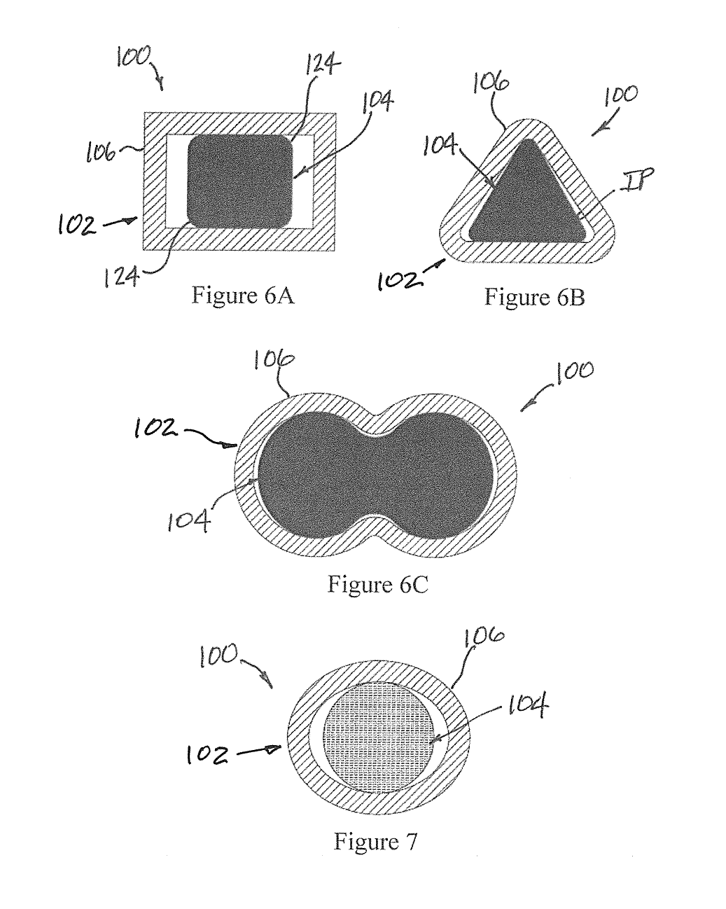

FIGS. 6A-6C show a single coil section of a filled canted coil spring 100. As with other single coil sections, the filled spring is understood to include a plurality of coils 106 all canted along the same direction. The figures show a variety of cross-sectional profiles that the plurality of coils 106 of different canted coil spring rings 102 and the filler materials 104 may embody. FIG. 6A shows a cross-sectional profile of a coil 106 and the filler material 104 wherein both the coil and the filler material are generally polygonal, such as square or rectangular, in geometry. The filler material 104 may include rounded corners 124. FIG. 6B shows a cross-sectional profile of a coil 106 of a canted coil spring 102 and a filler material 104 wherein both the coil and the filler material 104 are generally triangular in geometry. As shown, not all of the exterior surfaces of the filler materials 104 contact the interior perimeter IP of the coils 106. FIG. 6C shows a cross-sectional profile of a coil 106 of a canted coil spring 102 and a filler material 104 wherein both the coil 106 and the filler material 104 are of complex geometries. For purposes of the present disclosure, the present complex geometries can be described as a number “8” configuration. Such figure illustrates that the cross-sectional outer profile of the filler material 104 is always within the boundaries of the cross-sectional inner profile of the coil 104 regardless of the geometry of the coil and the filler material. In some instances the entire exterior surfaces of the filler material 104 contact the interior perimeter of the coils 106, only part of the exterior surfaces of the filler material contact, or none of the exterior surfaces contact.

In some embodiments, parts of the filler material 104 can protrude between gaps of two adjacent coils.

FIG. 7 shows a cross-sectional profile of a coil 106 of a canted coil spring 102 and a filler material or member 104 of a filled canted coil spring 100 wherein the filler material 104 is conductive. Conductive filler material may be preferred in some applications in which the application requires electrical current to flow along or through the coils of a canted coil spring and along or through the filler material. In an example, the filler material may include a wire cage to facilitate conductivity. The filler material or member alternatively or additionally include a plurality of conductive particles or elements, such as conductive flakes, filled within and about the surfaces of the filler member.

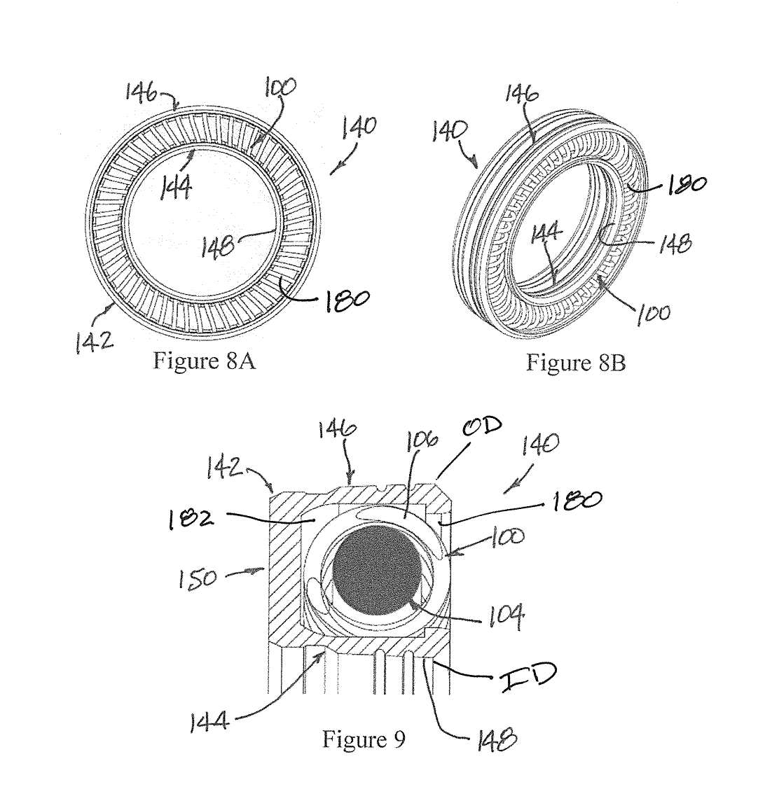

FIG. 8A shows a front view of a seal assembly 140 wherein a filled canted coil spring 100 is used as a spring energizer within a seal member 142 to illustrate the use of a filled canted coil spring 100 in a sealing application, such as in a rotary or reciprocating shaft application wherein the seal assembly is placed into a gland, which may viewed as a housing for the seal assembly during service. The filled canted coil spring 100 may be any one of the filled canted coil springs discussed elsewhere herein. The seal member 142 has a seal body that is generally C-shape and comprises an inside flange 144 comprising a sealing lip 148 and an outside flange 146, which are connected to one another by a center channel section 150 (FIG. 9). A gap or open channel 180 is provided on a side opposite the center channel section 150 as a means for assembling the filled canted coil spring 100. The seal body defines a spring holding space 182 for accommodating the filled canted coil spring 100 therein.

FIG. 8B shows an isometric view of the seal assembly 140 of FIG. 8A wherein a filled canted coil spring 100, which has a filler material 104 located within the coils 106 of the canted coil spring 102, is used as a spring energizer. The filled canted coil spring 100 displaces space that mud or materials can otherwise collect and build-up.

FIG. 9 shows a cross-sectional profile of a seal assembly 140 wherein the filled canted coil spring 100, which comprises a plurality of coils 106 and a filler material 104, is used as a spring energizer. The filled canted coil spring 100 is located inside a seal member 142, which has an inside flange 144, an outside flange 146, and a center channel section 150 connecting the two flanges 144, 146. The seal member 142 has an inside diameter ID and an outside diameter OD and a seal lip 148 located on the inside flange 144.

Method of use and of manufacturing filled canted coil springs and seal assemblies and their components are within the scope of the present disclosure.

Although limited embodiments of filled canted coil spring assemblies, seal assemblies with filled canted coil springs and their components have been specifically described and illustrated herein, many modifications and variations will be apparent to those skilled in the art. Accordingly, it is to be understood that the filled canted coil spring assemblies and their components constructed according to principles of the disclosed devices, systems, and methods may be embodied other than as specifically described herein. The disclosure is also defined in the following claims.

What is claimed is:

1. A spring assembly comprising:
a canted coil spring comprising a plurality of coils, a centerline formed through said coils, and a loading direction that is generally perpendicular to a tangent of said centerline;
wherein at least a coil of said plurality of coils comprises a cross-sectional inner profile when viewed in a direction of said centerline;
wherein at least a coil of said plurality of coils is deflectable generally independently of an adjacent coil of said plurality of coils when a load is applied in said loading direction;
a filler member disposed within said plurality of coils in the direction of said centerline;
wherein said filler member comprises a cross-sectional outer profile when viewed in the direction of said centerline; and wherein said cross-sectional outer profile of said filler member is within said cross-sectional inner profile of said plurality of coils when the canted coil spring is not loaded.

2. The spring assembly of claim 1, wherein said plurality of coils each is deflectable generally independently when loaded.

3. The spring assembly of claim 1, wherein said filler member prevents unwanted material to be filled or packed within said plurality of coils that may hinder the performance of the spring assembly when loaded while allowing for minimal effect on the generally independent deflection characteristic of said plurality of coils when loaded.

4. The spring assembly of claim 1, further comprising a seal member having a body with an open channel encompassing a cross-sectional outer profile of the canted coil spring.

5. The spring assembly of claim 1, wherein the filler member is hollow.

6. The spring assembly of claim 1, wherein the filler member comprises a cross-sectional outer profile that is not round.

7. The spring assembly of claim 1, wherein the filler member is an O-ring.

8. The spring assembly of claim 1, wherein the filler member is conductive.

9. The spring assembly of claim 1, wherein the plurality of coils each comprises a cross-sectional inner profile that is other than round or elliptical.

10. The spring assembly of claim 1, wherein the filler member is made from a sponge material or a foam material.

11. The spring assembly of claim 1, for use as an electrical contact.

12. A method for limiting material build up in a spring energized seal comprising:
providing a seal body comprising an outer flange and an inner flange connected to a center channel section, said seal body further comprising an open channel and a spring holding space;
providing a canted coil spring comprising a plurality of coils with a filler member through the open channel of the seal body and into the spring holding space;
wherein at least a coil of said plurality of coils comprises a cross-sectional inner profile when viewed in a direction of said centerline;
wherein at least a coil of said plurality of coils is deflectable generally independently of an adjacent coil of said plurality of coils when a load is applied in said loading direction; and
wherein said filler member comprises a cross-sectional outer profile when viewed in the direction of said centerline; and wherein said cross-sectional outer profile of said filler member is within said cross-sectional inner profile of said plurality of coils when the canted coil spring is not loaded.

13. The method of claim 12, wherein said filler member contacts said cross-sectional inner profile of said plurality of coils.

14. The method of claim 12, wherein filler member fills in gaps between two adjacent coils of said plurality of coils.

15. The method of claim 12, further comprising a gland and wherein the method comprises placing the seal body with said canted coil spring and said filler member in said gland.

16. The method of claim 12, wherein the filler member is hollow.

17. The method of claim 12, wherein the filler member is an O-ring, a foam, or a sponge.
